(19) United States
(12) Patent Application Publication
(10) Pub. No.: US 2010/0101734 A1
(43) Pub. Date: Apr. 29, 2010

(54) Tape Dispenser

(76) Inventors: Yen-Chen Chang, Kaohsiung City (TW); Shih-Yen Huang, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/260,149

(22) Filed: Oct. 29, 2008

(51) Int. Cl. B65H 35/07; B26F 3/02

(52) U.S. Cl. 156/527; 225/33

(57) ABSTRACT

A tape dispenser of the present invention has a main body and a first moveable portion. The main body has a containing space, a positioning slot, a second moveable portion and a handle. The first moveable portion is pivoted to one end of the second moveable portion, and the first moveable portion further has a first cutting element, a tape guiding element and a positioning pin. The tape guiding element is pivoted to the first moveable portion. Another end of the second moveable portion is pivoted to the handle, and the second moveable portion further has a second cutting element; and the tape guiding element has a pressing element and at least one protruding portion.

### BACKGROUND OF THE INVENTION

1. Field of the Invention

The present invention relates to a tape dispenser, and, more particularly, to a tape dispenser having two operating status.

2. Description of the Related Art

Tape dispensers are common office supplier, because the tape dispenser can easily dispense tape with desired lengths. Even though the tape dispenser can be placed in a convenient location, it can still be inconvenient for users to repeatedly grab and place the tape dispenser.

For example, in order to post a huge number of posters, it usually takes two people to finish the work; one person needs to tear the tape, and the other needs to post the poster. If there is only one person, it is even more difficult to finish the work.

Furthermore, the tape dispenser is often used to seal boxes; however, typical tape dispenser for sealing boxes usually has large size and cannot be utilized for other purposes.

Therefore, it is desirable to provide a tape dispenser to obviate the aforementioned problems.

### SUMMARY OF THE INVENTION

A main objective of the present invention is to provide a tape dispenser having two operating status.

In order to achieve the above-mention objective, the tape dispenser of the present invention comprises a main body and a moveable portion. The main body comprises a containing space, a positioning slot, a moveable portion and a handle. The first moveable portion is pivoted to one end of the second moveable portion, and the first moveable portion further comprises a first cutting element, a tape guiding element and a positioning pin. The tape guiding element is pivoted to the first moveable portion. Another end of the second moveable portion is pivoted to the handle, and the second moveable portion further comprises a second cutting element; and the tape guiding element comprises a pressing element and at least one protruding portion.

Other objects, advantages, and novel features of the invention will become more apparent from the following detailed description when taken in conjunction with the accompanying drawings.

### BRIEF DESCRIPTION OF THE DRAWINGS

FIG. 1 is a structure drawing of an embodiment of the present invention.

FIG. 2 is a schematic drawing of the embodiment of the present invention.

FIG. 3 to FIG. 5 are schematic drawings of a first operating status according to the embodiment of the present invention.

FIG. 6 is a schematic drawing of a second operating status according to the embodiment of the present invention.

FIG. 7 is a schematic drawing of a securing set according to the embodiment of the present invention.

FIG. 8 to FIG. 9 are schematic drawings of a second operating status according to the embodiment of the present invention.

### DETAILED DESCRIPTION OF THE PREFERRED EMBODIMENT

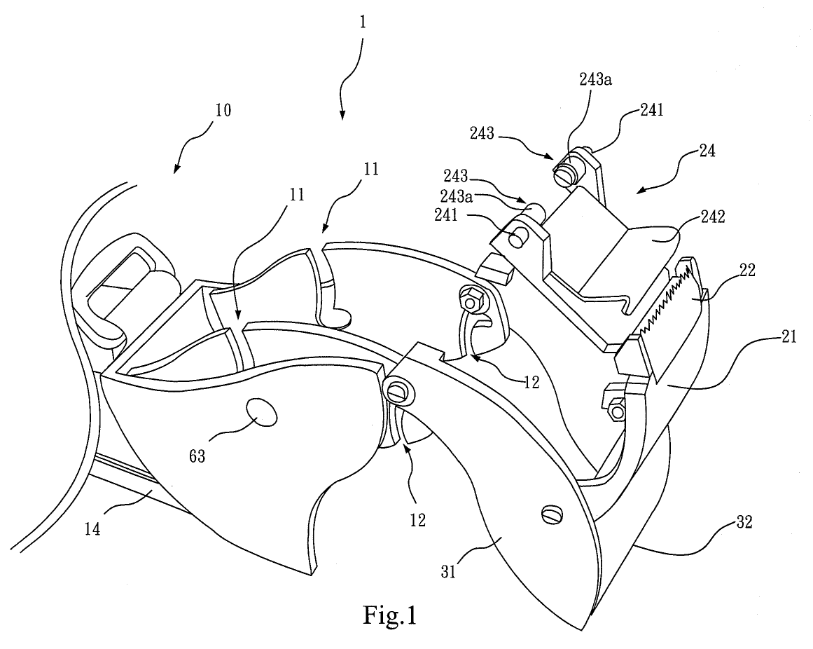

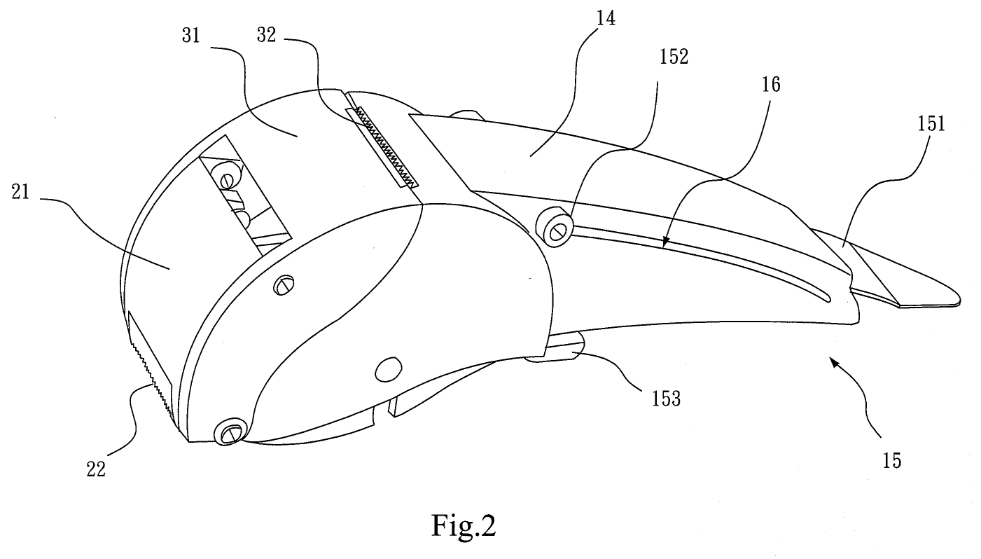

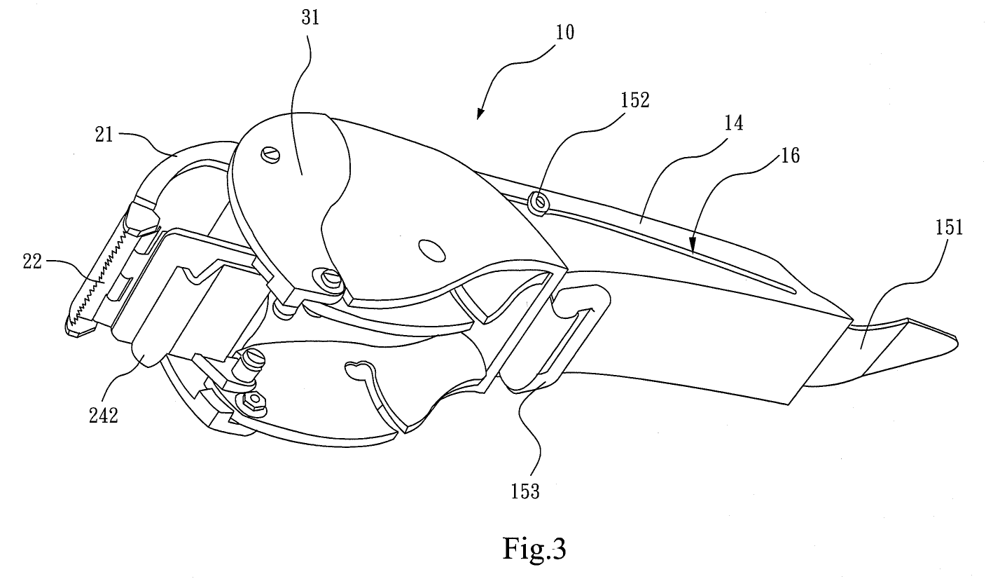

Please refer to FIGS. 1˜5. FIG. 1 is a structure drawing of an embodiment of the present invention. FIG. 2 is a schematic drawing of the embodiment of the present invention. FIG. 3 to FIG. 5 are schematic drawings of a first operating status according to the embodiment of the present invention.

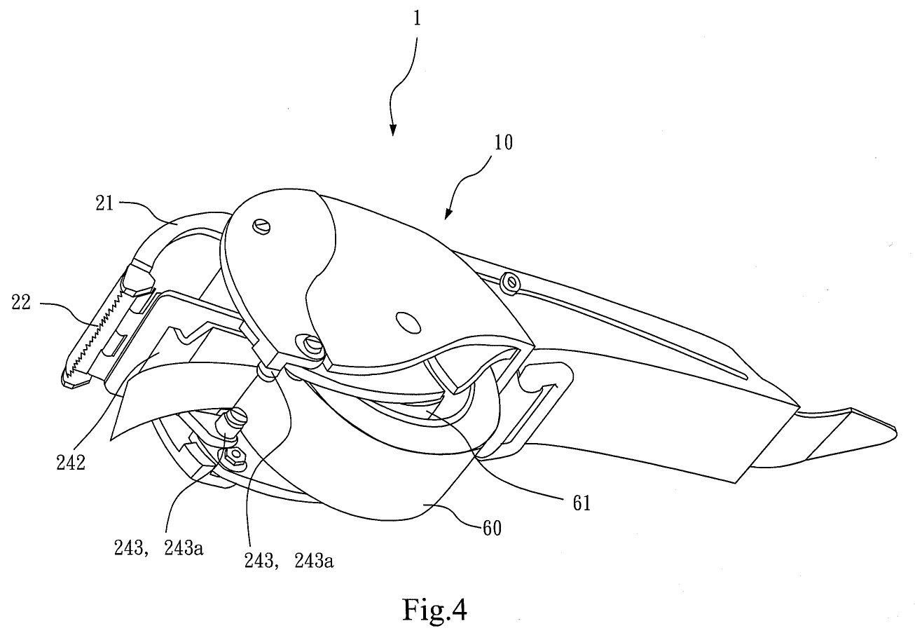

As shown in FIG. 1, a tape dispenser 1 for holding a tape 60 (as shown in FIG. 4) comprises a main body 10, a first moveable portion 21, a tape guiding element 24 and a tape shaft 61.

The main body 10 comprises a second moveable portion 31 and a handle 14, and the second moveable portion 31 is pivoted to the handle 14. The handle 14 comprises a containing space 11 and a positioning slot 12.

One end of the first moveable portion 21 is pivoted to the second moveable portion 31. The first moveable portion 21 comprises a first cutting element 22, and the first cutting element 22 is a saw-toothed blade for cutting the tape 60.

In this embodiment, the tape guiding element 24 is pivoted to the first moveable portion 21, and the tape guiding element 24 comprises a positioning pin 241. When the tape dispenser 1 is in a first operating status, the positioning pin 241 is secured in the positioning slot 12.

One end of the second moveable portion 31 is pivoted to the handle 14, the second moveable portion 31 has a second cutting element 32, and the second cutting element 32 is a saw-toothed blade for cutting the tape 60. The position design of the first cutting element 22 and the second cutting element 32 are matching different operating status of the tape dispenser 1.

The containing space 11 is used for containing the tape 60, and the containing space 11 further has a magnet 63 which is attracted to the tape shaft 61. The tape shaft 61 holds the tape 60, and the tape shaft 61 rotates in the containing space 11. The tape shaft 61 includes some magnetic material (for example, the two ends of the tape shaft 61 have iron material) which is attractive to the magnet 63.

A user places the tape 60 on the tape shaft 61 and then moves them to the containing space 11 of the main body 10. Since the magnet 63 is attached on the tape shaft 61, the tape shaft 61 can be easily placed and position in the containing space 11.

The tape guiding element 24 comprises a positioning pin 241, a pressing element 242 and a protruding portion 243. The protruding portion 243 is used for guiding the tape 60 to be pulled out along the same direction as the first cutting element 22. In this embodiment, the protruding portion 243 further has a roller 243a. The pressing element 242 presses the tape 60 down to attach to an object (such as a box). The positioning pin 241 can be secured in the positioning slot 12 so the tape guiding element 24 is secured to the main body 10.

In order to help the user to operate the tape dispenser 1, in this embodiment, the handle 14 further comprises a securing set 15 and guiding holes 16. The securing set 15 comprises a connecting element 151 and a driving element 152, and the driving element 152 moves in the guiding holes 16 and drives the connecting element 151. Furthermore, the connecting element 151 comprises a connecting ring 153. When the user wants to use the connecting element 151, he or she moves the connecting element 151 from the handle 14 and connects it to connecting ring 153 in his or her palm. When the user does not need the connecting element 151, he or she can use the driving element to move along the guiding holes to bring the connecting element 151 back in the handle 14.

As shown in FIG. 2, the tape guiding element 24 is placed in the first moveable portion 21; the first moveable portion 21 is placed in the second moveable portion 31; and the second moveable portion 31 is adjacent to the handle 14. When the tape dispenser 1 is not open up, it has small size which is easy for carrying around and storage, and the user will not get cut by the first cutting element 22 or the second cutting element 32.

The tape dispenser 1 has two operating status: the first operating status is suitable for the tape dispenser 1 to work on a large area (such as sealing a box); and the second operating status is suitable for the tape dispenser 1 to repeatedly paste and cut the tape with both hands (such as posting poster).

Please refer to FIG. 3 to FIG. 5 together. FIG. 3 to FIG. 5 are schematic drawings for the first operating status of the present invention. In order to have the first operating status, first the first moveable portion 21 is pivoted out from the second moveable portion 31, then the tape guiding element 24 is pivoted to a predetermined angle so the positioning pin 241 is secured in the positioning slot 12 (as shown in FIG. 3).

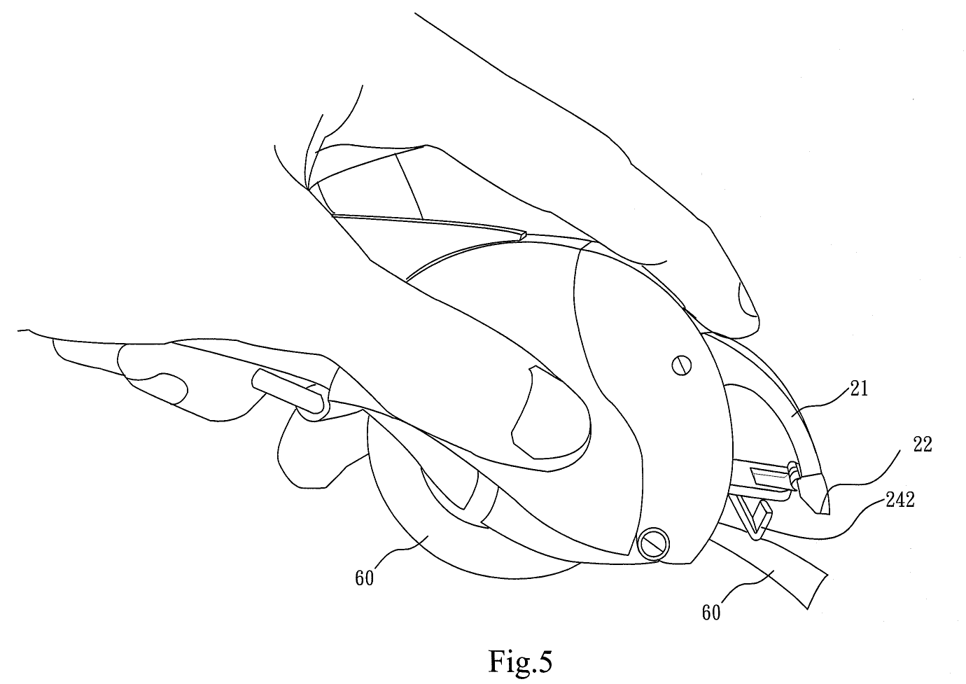

When the user wants to operate tape dispenser 1 in the first operating status, the user needs to hold the main body 10, stick the beginning end of the tape 60 on the object (such as a box), and drag the tape dispenser 1 to move the main body 10, so the tape 60 is guided by the protruding portion 243 and keeps rolling in the same direction (as shown in FIG. 4 and FIG. 5). Furthermore, the pulled out tape 60 is pressed by the pressing element 242 to adhere to the object. When the tape 60 reaches the desired end position, the user pushes the tape dispenser 1 to tip forward and down, and the first cutting element 22 cuts off the tape 60.

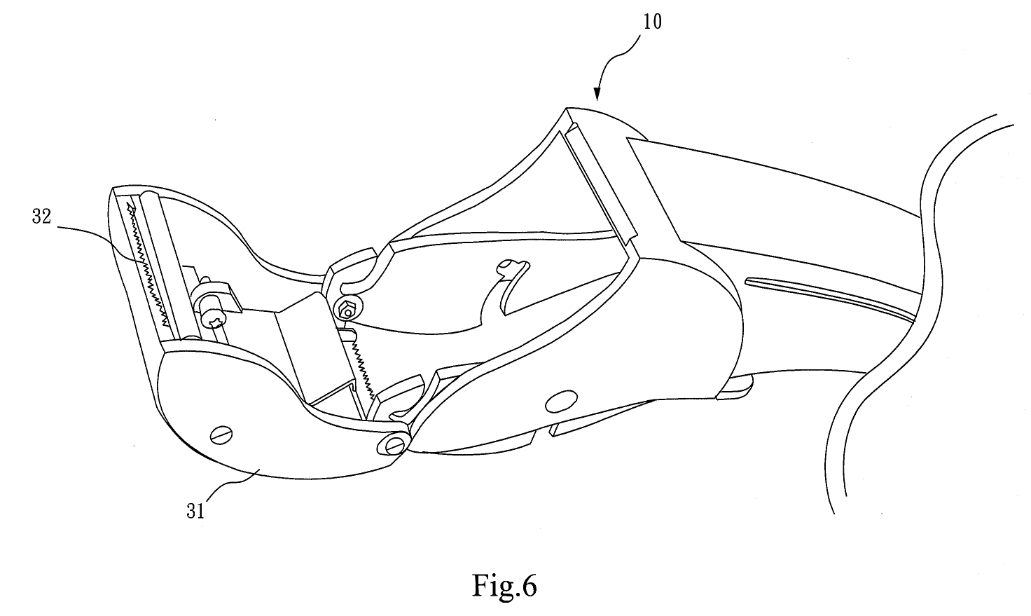

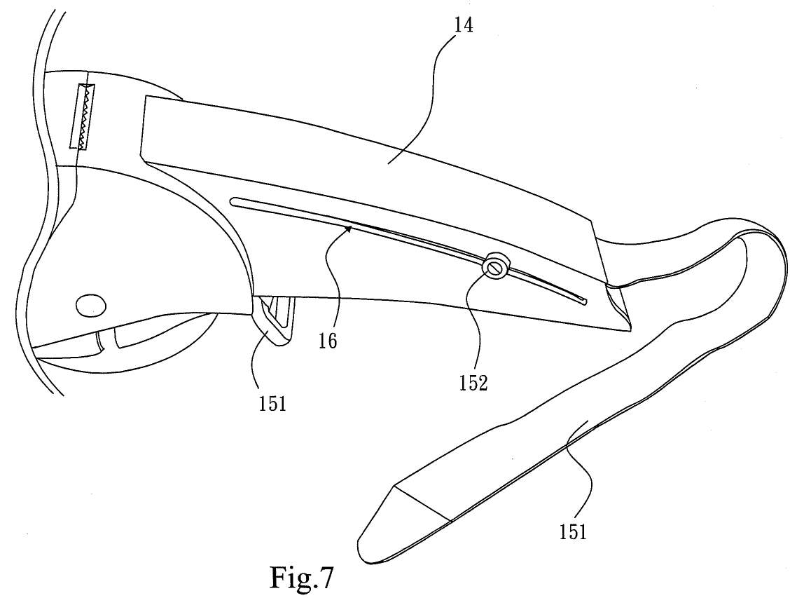

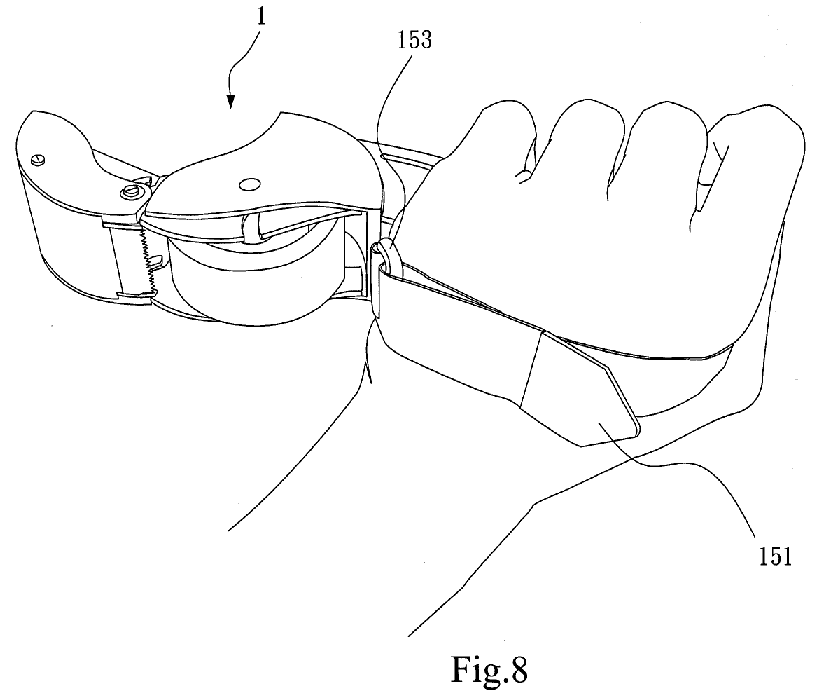

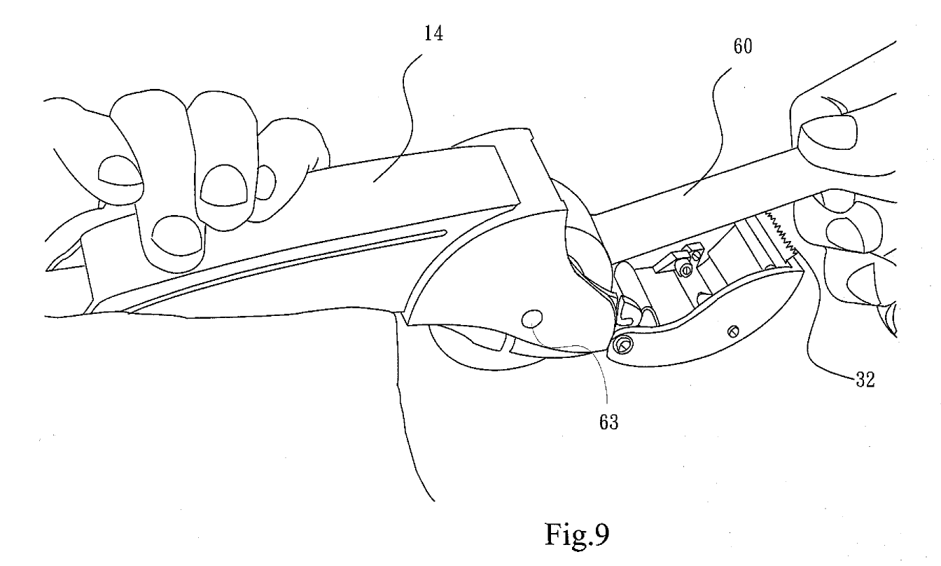

Please refer to FIGS. 6˜9. FIG. 6 is a schematic drawing of a second operating status according to the embodiment of the present invention. FIG. 7 is a schematic drawing of a securing set according to the embodiment of the present invention. FIG. 8 to FIG. 9 are schematic drawings of a second operating status according to the embodiment of the present invention.

When the user wants to operate the tape dispenser 1 in the second operating status, the user needs to rotate the second moveable portion 31 out from the main body 10 (as shown in FIG. 6). Next, the user holds the connecting element 151 in his or her palm, wherein the connecting element 151 can be any type of strap, in this embodiment, the connecting element 151 is Velcro (as shown in FIG. 7), which can be wrapped around the user's palm and connected to the connecting ring 153 (as shown in FIG. 8, the tape dispenser 1 is attached to the user's left hand). Next, the user can easily pull out the tape 60 to a desired length (as shown in FIG. 9), and use the second cutting element 32 to cut the tape 60. In this embodiment, when the user operates the tape dispenser 1 in the second operating status, although the tape dispenser 1 is attached to the user's left hand, the user can still use the left hand (especially the fingers) to assist the other hand for cutting and pasting the tape.

Although the present invention has been explained in relation to its preferred embodiment, it is to be understood that many other possible modifications and variations can be made without departing from the spirit and scope of the invention as hereinafter claimed.

What is claimed is:

1. A tape dispenser for holding a tape, the tape dispenser comprising:
a main body having a containing space, and the containing space is used for containing the tape;
a first moveable portion pivoted to the main body, the first moveable portion having a first cutting element; and
a tape guiding element pivoted to the first moveable portion;
wherein the tape dispenser has a first operating status: the first moveable portion is protruding from the main body, and the tape can be cut by the first cutting element.

2. The tape dispenser as claimed in claim 1, wherein the main body comprises at least one positioning slot, the tape guiding element comprises at least one positioning pin; when the tape dispenser is in the first operating status, the positioning pin is secured in the positioning slot.

3. The tape dispenser as claimed in claim 1, wherein the main body further comprises a second moveable portion and a handle, the second moveable portion is pivoted to the handle, and the second moveable portion has a second cutting element; wherein the tape dispenser has a second operating status: the second moveable portion protrudes from the handle, and the tape can be cut by the second cutting element.

4. The tape dispenser as claimed in claim 3 further comprises a tape shaft, which is used for positioning the tape, and the tape shaft rotates in the containing space.

5. The tape dispenser as claimed in claim 3, wherein the tape guiding element further comprises a pressing element and at least one protruding portion; the at least one protruding portion guides the tape, and the pressing element presses the tape.

6. The tape dispenser as claimed in claim 3, wherein the handle further comprises a securing set and a plurality of guiding holes, the securing set comprises a connecting element and a driving element, the driving element is capable of moving in the plurality of guiding holes, and the connecting element can be stored in the handle.

7. The tape dispenser as claimed in claim 5, wherein the at least one protruding portion comprises at least one roller.

8. The tape dispenser as claimed in claim 6, wherein the connecting element is a strap.

9. The tape dispenser as claimed in claim 6, wherein the connecting element further comprises an adhesive strip and a connecting ring.

10. The tape dispenser as claimed in claim 4, wherein the containing space further comprises at least one magnetic, and the at least one magnet is attracted to the tape shaft.

11. The tape dispenser as claimed in claim 3, wherein the first cutting element or the second cutting element is a saw-toothed blade.

12. The tape dispenser as claimed in claim 3, wherein the second moveable portion is pivoted to the handle, and the first moveable portion is pivoted to the second moveable portion.

13. The tape dispenser as claimed in claim 3, wherein the tape dispenser has a storage status: when the first moveable portion is contained in the second moveable portion.

14. The tape dispenser as claimed in claim 2, wherein the main body further comprises a second moveable portion and a handle, the second moveable portion is pivoted to the handle, and the second moveable portion has a second cutting element; wherein the tape dispenser has a second operating status: the second moveable portion protrudes from the handle, and the tape can be cut by the second cutting element.

15. The tape dispenser as claimed in claim 14 further comprises a tape shaft, which is used for positioning the tape, and the tape shaft rotates in the containing space.

16. The tape dispenser as claimed in claim 14, wherein the tape guiding element further comprises a pressing element and at least one protruding portion; the at least one protruding portion guides the tape, and the pressing element presses the tape.

17. The tape dispenser as claimed in claim 14, wherein the handle further comprises a securing set and a plurality of guiding holes, the securing set comprises a connecting element and a driving element, the driving element is capable of moving in the plurality of guiding holes, and the connecting element can be stored in the handle.

18. The tape dispenser as claimed in claim 16, wherein the at least one protruding portion comprises at least one roller.

19. The tape dispenser as claimed in claim 14, wherein the second moveable portion is pivoted to the handle, and the first moveable portion is pivoted to the second moveable portion.

20. The tape dispenser as claimed in claim 14, wherein the tape dispenser has a storage status: when the first moveable portion is contained in the second moveable portion.
